(19) United States
(12) Patent Application Publication
(10) Pub. No.: US 2015/0287136 A1
(43) Pub. Date: Oct. 8, 2015

(54) Method for Increasing Geographic Retention of Graduates by Reducing Student Loan Interest Rates Through Private Investment and a Secondary Bond Market

(71) Applicant: Shady Henien, Stratford, CT (US)

(72) Inventor: Shady Henien, Stratford, CT (US)

(21) Appl. No.: 14/245,185

(22) Filed: Apr. 4, 2014

(51) Int. Cl. G06Q 40/02

(52) U.S. Cl. CPC G06Q 40/025; G06Q 50/20

(57) ABSTRACT

The method of the present invention attracts two groups of direct customers; grad students and investors and two passive groups of customers who will also benefit from these trades and investments; society and school institutions. The method provides cheaper interest rate student loans than offered by government sources and variable rates by private corporations; and provides the investors with relatively low risk investments that allow the investor to help address a community need. Preferably, the invention includes formation of a secondary tuition bond market to provide a means to liquidate the investor's investments in the tuition fund by trading/selling their student tuition bonds.

### PRIORITY STATEMENT

This application a nonprovisional application based off provisional application No. 61/809,042, which was filed on Apr. 4, 2013 with the U.S. Patent and Trademark Office, the entire contents of which is incorporated herein.

### FIELD OF INVENTION

The present invention relates, in general, to methods for retaining graduates from particular educational programs in a specific geographic area. More specifically, the invention provides to the graduates financial incentives for fulfilling a workforce need in a particular geography and to investors for investing for the purpose of incenting said graduates to stay. This invention also creates a novel investment tool by compiling student debt and selling it to investors in the form of “Student Tuition Bonds.” The invention also relates to a method for providing student loans at interest rates at or below that of the federal government sources for the dual purposes of satisfying a specific work force deficit in a geographic area and providing an investment vehicle or relatively low risk that includes a secondary bond market.

### BACKGROUND

The rising cost of post secondary education is a serious issue with future ramifications on career choice decisions of choosing a particular field or industry in which to work, location to work and live, and deterrence for the bright minds of future generations to choose a particular field of study, industry, business sector or profession in which to work versus a different career. Currently, we face a challenge to make post-secondary education more affordable so that we can continue to draw the best and brightest students into selected fields and related professions. Examples of such industry needs include retaining doctors in rural areas, certain engineering disciplines in particular locations, even skilled welders or other tradesmen in areas awarded long-term government contract or where a new pipeline or similar project requiring skilled-workers of particular trades is being built.

Take, for example, medical school students and the careers they elect post graduation. The U.S. will insure more than 32 million new American patients in 2014 and a growing number of Americans over the age of 65 years old.^{1,9} It is important to find ways to help decrease the cost of attendance for future medical students. In this country, it is mandatory that all physicians complete at least 3 years of residency after they receive a M.D. degree to be fully licensed. The Association of American Medical Colleges (AAMC) Center for Workforce Studies reported that there will be 45,000 too few primary care physicians and a combined 46,000 too few surgeons and medical specialists within the next decade.¹ Table 1¹ produced by the AAMC demonstrates physician shortages from 2008 to projections made for 2025.

TABLE 1
Physician Supply & Demand
Projected Supply and Demand, Full-time Equivalent Physicians
Active in Patient Care Post Health Care Reform, 2008-2025

| | | | | Physician |
|---|---|---|---|---|
| | Physician | Physician | Physician | Shortage |
| | Supply | Demand | Shortage | (Non-Primary |
| | (All | (All | (All | Care |
| Year | Specialties) | Specialties) | Specialties*) | Specialties) |
| 2008 | 699,100 | 706,500 | 7,400 | None |
| 2010 | 709,700 | 723,400 | 13,700 | 4,700 |
| 2015 | 735,600 | 798,500 | 62,900 | 33,100 |
| 2020 | 759,800 | 851,300 | 91,500 | 46,100 |
| 2025 | 785,400 | 916,000 | 130,600 | 64,800 |

Source: AAMC Center forWorkforce Studies, June 2010 Analysis
*Total includes primary care, surgical, and medical specialties
For more information, please contact Len Marquez, Director, Government Relations, AAMC, at lmarquez@aamc.org or 202-862-6281.

The cost of medical school has increased in the past 20 years as the rise of tuition has risen out of proportion to the rise in inflation.² The median cost of attendance for public medical schools in 2012-2013 for In-State Resident was $32,197 per year and Out-of-State Resident was $54,625. The median cost of attendance for private medical schools in 2012-2013 for both In-State Resident and Out-of-State Resident was greater than $50,000.³ All rates described in this patent are accurate as of May 2013. Most graduate school programs follow similar trends although the absolute costs may be a bit lower for some programs. The trends for higher costs of education are mirrored for qualified teachers, tradesmen, and a variety of other educations programs. The trends also lead to a higher cost of attendance for public institutions due to decreased governmental fiduciary support.

Projections made by the 2007 Medical School Tuition and Young Physician Indebtedness updates indicate that medical graduates by 2033 will graduate with a debt of $750,000.² This debt poses a threat to a student's medical career, future livelihood, decisions of medical specialty, and discourages qualified and high caliber students from entering the field of medicine. Graduates of other programs such as dentistry, law, and pharmacy also face high levels of indebtedness. The debt load poses a threat to the future quality and competence of those in many professions in the United States. Not to be overlooked, many other graduate and undergraduate programs send their graduates into the world with tens of thousands of dollars worth of debt. Trade schools tuitions also are not inexpensive, especially when paired with the graduate or certified student's expected income.

According to the AAMC October 2012 debt report card, the average debt for the class of medical doctorates in 2012 (public and private) was $166,750. Many medical students have also incurred debt from undergraduate school, which they have not yet repaid and 36% of 2012 medical school graduates had $20,000 of pre-medical education debt.⁴ Many medical graduates are forced to enter forbearance during residency with an extended repayment of their Federal Direct Loans with a sample repayment of $170,000 which would require take 25 years post-residency to repay meanwhile accruing $306,000 of interest with a new total repayment of $476,000.⁴ The residency Match in 2012 showed that many U.S. Allopathic medical seniors did not choose or match into primary care fields (i.e. Family Medicine—2,740 total positions filled by only 1,322 U.S. medical graduates; Internal Medicine—5,277 total positions filled by only 2,941 U.S. medical graduates; Primary Medicine—311 total positions filled by only 186 U.S. medical graduates; Pediatrics—2,475 total positions filled by only 1,732 U.S. medical graduates; Primary Pediatrics—67 total positions filled by only 27 U.S. medical graduates; Psychiatry—1,118 total positions filled by only 616 U.S. medical graduates).⁵ These fields of medicine typically do not reimburse as high as other fields of medicine that are more procedurally orientated.

What was needed was a student loan market that offers lower interest rates, and might function to entice graduates to stay in geographic areas where that profession or specialized skills are needed. Further, a loan market that offers a solid return for investors while allowing the investor to “invest” in retention of professionals needed in a given geography was needed, and not available.

What was needed was a method to retain graduates to work in a particular geographic area where a shortage of labor possessing that educational level or specialty is present, forecast, or both. A method was needed to incent both investors and graduates to maintain and increase their financial commitment to and participation in a particular geographic area and to dis-incent graduates from leaving a particular geographic area where their skills are needed.

It is an objective of the present invention to provide a method and a system for retaining graduates, especially of professional schools, in geographic areas where a shortage is otherwise occurring or predicted;

It is another objective of the present invention to provide a method for reducing interest rates for student loans below the rates or with better terms than those offered by the federal student loan programs;

It is still another objective of the present invention to provide a vehicle and a mechanism whereby an investor may invest in a fund by purchasing student debt with creation of novel “Student Tuition Bonds” that provides local benefit by retaining professionals or other graduating college students in the area;

It is yet another objective of the present invention to provide a method and means for investors to invest and then to recover their cash, if they wish, through a secondary tuition bond market.

### BRIEF DESCRIPTION OF THE DRAWINGS

FIG. 1 Diagram depicting the pillars and objectives of the present invention.

FIG. 2 A flow chart showing the cash flow of investment in the method of the present invention

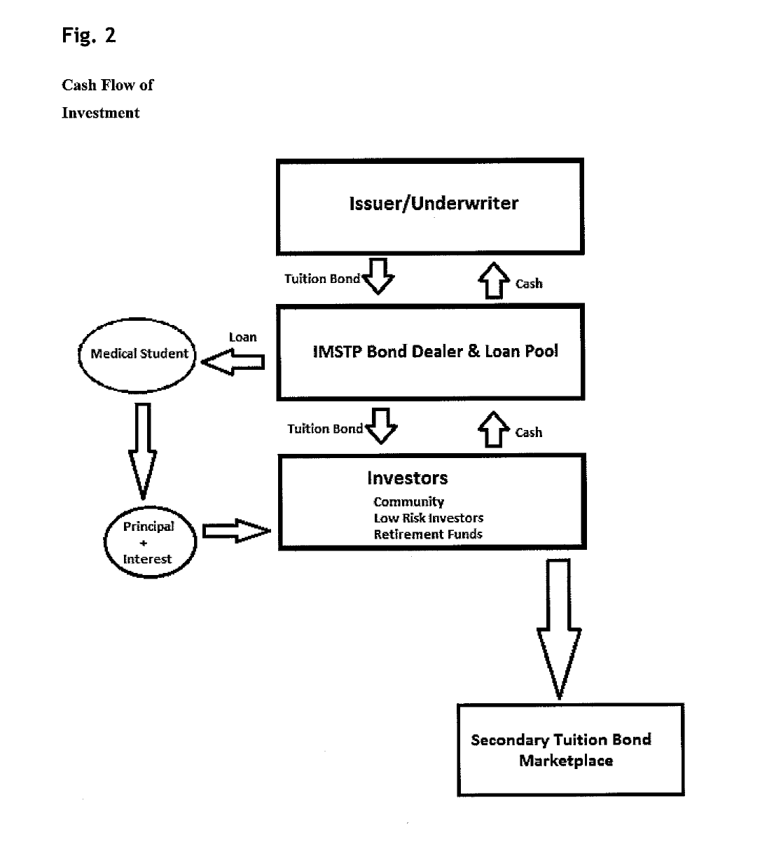

### SUMMARY OF THE INVENTION

A loan market has already been established by the exorbitant interest rates on student loans such that even a slight decrease in student loan rates will drive students to utilize a loan at the reduced rates. Under the present invention, this constant demand will be supplied by investors who are also searching for a low risk investment option and competitive return, especially those investors possessing a philanthropic attitude. This opportunity will entice social cause and low risk types of investors.

The method of the present invention attracts two groups of direct and identifiable customers; students and investors and two passive customers who will benefit from these trades and investments; society and school institutions. The identifiable customers are looking for cheaper interest rate loans than 6.8% offered by Direct Loans and variable rates by private corporations such as Sallie Mae and other banks. There are multiple types of investors, but the majority of investors can be described by one of the following six types or a combination of these types.

1. Short Term Investor: seek investment options with low price fluctuation and short time frame for their return on investment. Typical investment type: 100% bonds.

2. Cautious Investor: low risk behavior that seek short-dated and high-rated papers with minimal price variations. Typical investment type: 90% Bonds>10% Equities.

3. Simple Investor: seek investments with a minimum of 3 year time period and will accept roughly 4% to 5% loss initially with achieving a higher average returns in the future with stable returns greater than bond market averages. Typical investment type: 80% Bonds>20% Basic Equities.

4. Plus Investor: seek riskier investments for 3 to 5 years period and accept a maximum loss of 6% with anticipation of higher average returns than the simple investor. Typical investment type: 65% bonds and 35% equities.

5. Growth Investor: holds to investments for greater than 5 years and will accept a maximum loss of 8% with goals of achieving higher than average long term returns. Typical investment type: 55% Bonds and 45% Equities.

6. High-Growth Investor: hold onto investments for greater than 8 years and will tolerate 11% loss with goals of achieving higher than average long term returns. Typical investment types: 45% Bonds, 35% Basic Equities, and 20% Growth Equities.

The present invention includes a focus on a first group of customers which are socially responsible investors with short term or cautious investment strategies. The second group of customers included by the method is the student borrowers who demand a lower interest rate on student loans than the current 6.8% offered by Direct Loans. The mutual relationship between both sets of customers will serve to sustain this business venture for many years. The bonds held by investors issued by banks associated with the present invention will be able to be traded in the “Student Tuition Bond Aftermarket Place.” The passive customers include society and educational institutions.

Using medical students as an example, by 2020 there will be over 106,836 US medical students who will require student loans, which equates to a yearly finance amount of $4,453,725,750 ($166,75014×106,836 students). This general applicability also supports the concept of offering student tuition bond investments for dental, pharmacy, and top tier business and law schools, and may be modeled for use in managing debt in certain undergraduate fields as well as trade school debt.

The goal of the invention is to interest enough students and recruit enough investments to fund an entire first class which, using the example of medical students, will roughly cost $6 million in private investments. The present invention contemplates bonds issued by an underwriter that can be traded by investors for gains in the newly created Student Tuition Bond Marketplace.

Graduate school institutions support this measure since it can be used as a marketing tool to attract student applicants to their school. For example, Medical schools are evaluated by the Liaison Committee on Medical Education (LCME) which is the national accreditation body for all U.S. medical schools. The LCME has two defined standards published on-line that specify a medical school's role in student indebtedness.¹⁰ According to standards MS-23 and MS-24:

“A medical education program must provide its medical students with effective financial aid and debt management counseling. A medical education program should have mechanisms in place to minimize the impact of direct educational expenses on medical student indebtedness.” The LCME reviews and considers the average medical student debt, total number of medical students with scholarship support, institutional programs that enhance student tuition funding and helping students acquire external financial aid.

The targeted demographic of investors will include physicians, businessmen, philanthropic organizations, high-tax bracket individuals and corporations, and long-term retirement plans. The invention presents a unique idea that will attract new types of investments with interests of helping to ensure the success of particular professions in specific geographies and offers a reliable and low risk on investment.

The present invention is facilitated by transactions conducted through a secure web platform. Transactions and data storage may be facilitated by cloud computing. The transactions are facilitated by computers configured to allow money transmissions via a secure web platform and/or cloud computing and storage from investor to the bank where the funds are used to create bonds which are, in turn, held by the investors. Further transactions will include transfer of loan to the student, and processing of payments made by the loan recipient, again via at least one computer configured to facilitate these transactions and preferably through a secure web platform.

In January 2013, Direct Stafford Loans; government backed loans were unsubsidized (loan accrues interest during the full lifetime of the loan) at a fixed 6.8 percent interest rate. Unsubsidized Stafford loans for Health Professions Students are limited annually (the limit was $32,000 in 2012). The Budget Control Act of 2011 (BCA, P.L. 112-25) eliminated subsidized Stafford loans for all graduate/professional students. The increased accrued interest had an estimated increase of at least $20,000 over the life of the medical student's loan. Since the cost of attendance to medical school is much greater than the annual limit this forces many medical students to seek other loan options including government backed GradPLUS Loans, which are unsubsidized loans with a fixed 7.9 percent interest rate as of 2013.¹¹ Presently, taxpayer money is used to fund these federally backed student loans while taxpayers do not receive direct investment benefits from the 6.8% accrued interest. In contrast, the present invention allows taxpayers and private investors to benefit from investments in student loans directly while helping students pay less in accrued interest on student loans.

According to CNN Money, stocks offer the highest average rate of return of 10% in the long term. U.S. Treasury long term bonds offer 5% return on investment. Both of these investment tools are risky and returns are not guaranteed.⁸

Currently, tuition is funded mostly by either governmental student financial aid or private resources. For example purposes only, the majority of the Department of Education's loan programs for medical students are authorized under Title IV of the Higher Education Act (HEA). The Health Resources and Services Administration coordinate the Primary Care Loan which is authorized under Title VII of the Public Health Service Act. First, federal government loans provide the majority of funding to students for the college or graduate school loans. Most of these loans will incur interest, but do not require credit checks or collateral. Student loans include Federal Stafford and Federal Perkins Loans.⁶ All Stafford Loans are either subsidized or unsubsidized. All students are eligible for unsubsidized Stafford Loans which has a fixed interest rate of 6.8% for loans with a first disbursement after Jul. 1, 2006.⁶ Stafford Loans have loan fees of 4% which are deducted from the disbursement check. Graduate students are not qualified for all of the same loan rates and deals as undergraduate students, so as an example, medical student rates and options are described herein. Medical students are not eligible for the subsidized Stafford Loans due to the Budget Control Act of 2011 (BCA, P.L. 112-25). This Act will increase repayments for medical students between $10,000 and $20,000 for their loans.⁷ Medical students have an annual unsubsidized limit ($32,000 in 2012).⁶ The aggregate loan limit is a combined base limit for subsidized and unsubsidized Stafford Loans and for medical students was $65,000 in 2012 with an additional limit for unsubsidized loans of $158,500. GradPLUS Loans are unsubsidized loans with a fixed interest rate (7.9% in 2012-2013).

Next, the Perkins Loan is awarded to both undergraduate and graduate students who display exceptional financial need. The school or institution serves as the lender provided by government funds. This is a subsidized loan with a 9-month grace period post-graduation. As of 2012, the interest rate was 5% for a 10-year repayment period. The maximum limit for graduate students was $8,000 per year.⁶

Competitive Profile (example only)

| Company | | Sallie Mae | | |
|---|---|---|---|---|
| -OR- | | (other loan | | Municipal |
| Investment Tool | The present invention | servicers) | Stocks | Bonds |
| ROI | 1. estimated 3%-5% (low | Stock dropped 35 | Average 10% | Highest: |
| | risk without investor | points over 10 | long term | 6.75% 16 year |
| | maintenance) | years | (High risk, | maturity for |
| | 2. Tradable Student Tuition | (High: $57.90 | unstable | retirement |
| | Bonds in Secondary Market | Today: $20.31) | economy and | home. |
| | | | volatile market | Lowest: |
| | | | place) | 0.300% 1 year |
| | | | | maturity POT. |
| | | | | Co. |
| Student Attraction | Pre-STEP 1 Exam: 6% | Minimum 6.8% | N/A | N/A |
| (Loan Interest | Post-STEP 1 Exam: 5.5% | with cap of | | |
| Rate) | | $32,000 annually | | |
| Benefits to | 1. Reversible Affordable | 1. College Loan | Tax | Helps |
| specified | Care Act Tax Incentive for | Information and | | communities |
| geography | Citizens of Iowa | Guides | | and local |
| (example: IOWA) | 2. Retain more physicians | 2. Large | | industries |
| | 3. Capital Formation | infrastructure | | |
| | 4. Scholarship Donations | | | |
| | 5. Likely residence retention | | | |
| | beyond required with | | | |
| | positive tax revenues to | | | |
| | state. | | | |
| Tax Incentive | 1. One Year Personal | None for Investor | None | Tax-free ROI |
| | Income Tax Credit | | | |
| | 2. Tax-Free on gains from | | | |
| | Tuition Bonds (proposed) | | | |
| Management | Experienced medical school | Complex | 1. Self-trade | Management |
| | student alumni, business | | (high risk) | Fees |
| | professionals, and legal | | 2. Portfolio | |
| | counsel team | | management | |
| | | | fees | |

### DETAILED DESCRIPTION OF THE PRESENT INVENTION

The invention comprises, in part, Student Tuition Bonds for students pursuing degrees or certifications that have or are predicted to have specific benefit to a particular geographic area, which bonds are sold via platform and electronic transfer of funds. The invention further comprises offering student loans at attractive interest rates. Non-limiting examples of students may include those attending and graduating from medical, pharmacy, dental, top 10 MBA, and tier 1 law school students. These loans will be sold to private investors via platform and electronic transfer.

The method includes a for-profit subsidiary responsible for the transaction structure within a newly created secondary marketplace for tradable tuition bonds. This will allow the investor to liquidate his debt purchase commitment. This combination provides means to address the shortages of certain types of professionals in a particular geographic area. For example, the state of Iowa needs more rural and small town medical professionals. By decreasing the tuition debt burden incurred by most graduate students, and conditioning that reduction on the graduate's employment within the geographic area in one of the identified categories of professionals needed, the invention creates a mutually beneficial arena for addressing both needs. This invention is the first of its kind to address the financial burden created by exorbitant Direct Loans interest rates (6.8%) while connecting a community and state together to invest in the future of its doctors, dentists, pharmacists, business leaders, and lawyers and other certified or specialty laborers. In sum, the invention allows students to pay less in total student education loan accrued interest and investors make a safe and reliable return on their investments.

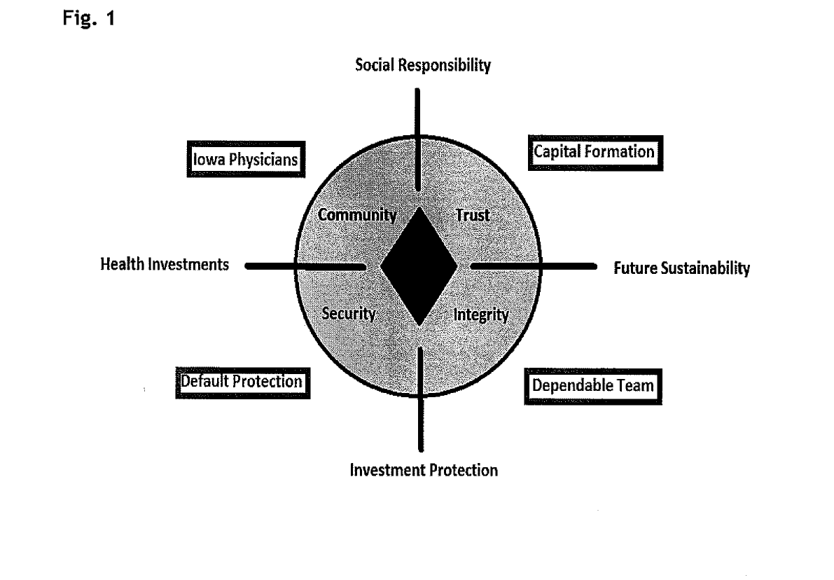

The customer value proposition will assure the best interests of graduate students and investors in the specified locale and abroad. The invention is built upon four pillars: community, trust, security, and integrity (see FIG. 1) and provides tools and methodology to deliver safe and reliable investments while ensuring a decrease in the debt burden of graduate students while encouraging them to stay and practice medicine in the specified locale. For example, in one embodiment, the loans may be of stepped interest; higher if the student leaves the specified locale before passage of a specified amount of time, lower if they stay. With particularity, one example of the stepped interest may be described as a 15 year loan at a 4 year zero (6%, 6%, 5.5%, 5.5%)+11 year amortization period at 3.4% while a second example of a stepped interest could include a 15 year loan where, so long as the student stays and works for a given period in the state, say, for example, 5 years, the loan is a 4 year zero at 3.68%+11 year amortization period at 1.68%. The invested funds will grow and remain self-sustainable by different interest rate metrics and investments of gains to insure that investors are paid on time and defaults are kept to a minimum. The creation of a secondary marketplace for the trading of tuition bonds will allow investors to regain their cash by selling their tuition bond to other investors for a gain or loss.

The invention is easy to use for both students and investors. Each of the individual students and the investors creates a profile on the secured web platform where money will be transferred from the investor to a specified bank account which will serve as the central collection platform. The student applicants will create a profile and submit financial history information for security risk assessment purposes including, for example, one or more of the following: grade point, current program, progress or status, credit scores, income, previous tax report, and co-signer. The company will then distribute the funds to participating students. In summary, the investor will not invest in a particular student but rather purchase a portion of the collective student debt comprised from compiling all student debt from a given year. This will diversify the risk for investors as well as maintain a sense of anonymity for the students. Customer service support is available. The system offers a faster response and disbursement of funds to students than the current time frame of Direct Loans. The reliable transfer of funds to a student's bank account will be communicated between the system's bank and the borrower's bank account.

A benefit of the present invention is that it does not trade government backed student loans and creates a sense of community and teamwork between investors and their state-located students. The objective is to maintain a sense of unity between investments in a pool of money for students that the investor may actually meet during the student's stay or residency in the state. The system, in essence, repositions the capital in the hands of the investors to invest into the “type” of graduate or professional student the investor wishes while making a stable and secure return on their investment. This is in contrast to the current use of federal taxpayer money for higher interest student loans to students where the tax payer does not have a social, community, or personal connection. The decreased debt is enough of a driving force to capture the student market. Investors lend their support for this service because of the philanthropic and societal need for more of certain kinds professionals in their own geographic area as well as a safe return on their investment.

A default in the present invention is defined as a monthly loan payment unpaid for a given amount of time. For example, this time frame may be expressed in days such as 270 days. Ramifications of such a default may include garnishment of net income and lowered credit report score. It is possible for the system to be set to provide such loans only to a student who has reached a certain plateau or status in the program in which he is enrolled, therefore increasing even further the likelihood of completion. In any event, the system provides a relatively low risk investment since the graduate level student drawing on these funds has a high likelihood of graduating and becoming a licensed medical doctor or other professional upon the completion of school. It is also in the graduate or medical school's best interest to help all of their graduating students find jobs (i.e. residency by Match Day in March of each year). And, of course, it is in the student's best interest to find such employment. If the student accepts the loan through the present invention, he will be more likely to cultivate relationships within the designated geographic area, and to consider residency and internship possibilities in accordance with the need to stay in order to obtain the lowest possible payback interest rate on the loan.

The inventive method offers tools to investors to protect their capital from the minimal chance of student default. For example, when providing loans to medical students, these protections may include self-financing the system via a 1% margin from Pre-STEP 1 Completed medical students which can be used to establish a default risk account that is invested independently and used in the unlikely event of student default or Act of God. The present invention requires that students submit a detailed profile upon applying for loans including a co-signer, credit check and score, and previous tax history before awarding a loan and helps students avoid default or delayed payments by partnering with independent default assistant agencies. A unique agreement with partnering banks to offer credit default swaps (CDS) for a charged premium to the investor for loan protection may also be provided. These specifics would be negotiated directly with the associated bank.

Three different bond transactions are available. All three financial tools preferably utilize a zero-coupon bond with conversion to amortization of the loan for the remaining life of the bond/loan for 15 years total. However, there are myriad combinations of coupons, amortization, and life of the bond/loan that may be employed by the present invention.

### Theme 1: Out-of-State Tuition Bond.

In this example, the student is not obligated to practice in the specified locality. The scale may be tuned to achieving various educational milestones in the educational program. Once more using as an example the medical student: the student may incur a sliding scale for interest rates varying from a first percent (e.g, 6%) prior to STEP-1 examination and a second rate (eg. 5.5%) after passing Step-1 examination. Upon matching at a residency in March of their 4^{th} year of medical school (or obtaining an offer for non medical students), the student's rate could decrease again (eg. To 3.4%) further below the Direct Loans rate. Using this example further, the investor anticipated ROI at time of maturation would be 49% and the student could save roughly 18% compared to Direct Loans at 6.8% interest rate. The average medical student carrying the average loan in this scenario could save over $50,000 over the life of the loan. Tax-free capital gains treatment from various state governments round out the opportunity on the Investor side.

### Theme 2: In-State Tuition Bond

This bond will commit any student in the state to remain and work in that state for a specified amount of time post graduation (or post-residency for grad programs requiring them). The objective is to retain students to become employed in their fields in the specified state as fully licensed/certified as required by the field. For example, a medical student may need to be employed in the state as a fully licensed physician in order to retain the lower interest rate. The rate may become reduced over time of residency and employment in the state, so long as the student remains current on payments. The incentive to the investor is a requested tax-credit and tax free returns from capital gains for State Income Tax. The student could save and the investor could receive a nice return on the life of his investment.

### Theme 3: Zero Converted to a Coupon Tuition Bond

Under this scenario, no interest will be paid to the investor for four years but the amount will be compounded to the initial investment with an annual coupon rate of 2%. The ROI and expected student savings could be determined in conjunction with the state government.

### Risk Stratification:

Students are grouped into high risk or low risk investments depending on their ability to acquire a cosigner, income verification form, tax history, credit score check, and dependents. Upon successful completion of STEP-1 (or other milestone in a professional school program) the student has dramatically increased his or her chances of matching into a residency and increased his or her likelihood of successful graduation. At this point, the student's rate may be negotiated. The system can include rating factors such as grade point or ranking within a class which may result in decreasing the risk.

Students are expected to make monthly payments to the fund managers who will pay the investors, payments may be bi-annually in December and June of each year or on some other predetermined payments schedule. The loan will be awarded to students in July and January of each year or other times of the year that are relevant to the program and the school.

The present invention has been described with the particularity necessary to enable one of ordinary skill in the art to practice the invention. However, the various examples provided herein are non-limiting; the invention may be applied at any interest rate or rates, loans may be provided on a variety of terms and rates may vary in accordance with any one or more of a plurality of characteristics of the student, the geographic area, the employment of the student, or the particulars of the educational program.

What I claim is:

1. A computer and web-enabled graduate and employee retention system comprising:
a) one or more computers configured to store information pertaining to one or more loan applicants, said information including for each said loan applicant at least one of identification of an educational program in which said loan applicant is enrolled, a geographic area where graduates from said educational program are needed to meet a work force deficit, and a progress indicator of said loan applicant's current position in said program;
b) one or more computers configured to process an application for a student loan by said at least one loan applicant;
c) one or more computers configured to award a loan to said applicant based on said applicant's enrollment in said program, said loan comprising an interest rate determined by any one or more of applicant's status in said program, applicant's place of residence, applicant's employment status, geography of applicant's employment wherein said employment status and geography of employment meet a preset criteria to meet said work force deficit.

2. The computer and web-enabled graduate and employee retention system of claim 1, further comprising one or more computers configured to track and process at least one loan payment made by said applicant and at least one of a plurality of characteristics of that payment said plurality comprising amount paid, amount due, date paid, present employment of said applicant, present residency of said applicant, present geography of employment, and present status in said educational program.

3. The computer and web-enable graduate and employee retention system of claim 2, said interest rate comprising variability relative to a time period in which said loan applicant retains said employment status in said geography of employment.

4. The computer and web-enabled graduate and employee retention system of claim 2 wherein said at least one computer comprises a computer programmed to accept loan applicant data in communication with a computer programmed to process said loan applicant data and award a loan.

5. The computer and web-enabled graduate and employee retention system of claim 2 wherein said at least one computer transmit, store, and process data via cloud computing.

6. The computer and web-enabled system of claim 2 further comprising one or more computers configured to accept and record data pertaining to an investment of money by at least one investor, said investment for at least the purpose of funding at least part of at least one student loan.

7. The computer and web-enabled system of claim 6 further comprising at least one computer configured to facilitate formation of and trading on a secondary bond market, comprising a plurality of student tuition bonds, each said bond representing one investor's investment intended to fund said at least one loan.

8. A method for addressing a work force deficit in a specific geographic area comprising increasing geographic retention of at least one recent graduate from an academic program related to said work force deficit, said method facilitated by one or more computers configured to provide at least one interest rate on at least one student loan to a loan recipient enrolled in said academic program, each said rate comprising dependency upon at least one condition of post-graduation employment and further comprising a secondary bond market.

9. The method of claim 8 further comprising a plurality of investors each providing an investment for funding said student loans, said secondary bond market based on said investor funding.

10. The method of claim 8, said at least one interest rate being more favorable to said loan recipient wherein said loan recipient obtains employment in said geographic area in a position that addresses said work force deficit.

11. The method of claim 8, said at least one condition of employment comprising employment in said specific geographic area.

12. The method of claim 8, wherein said at least one condition of employment comprises at least one of the following: employment in said geographic area, completion of said academic program, employment that addresses said work force deficit, length of time of employment, residency of said loan recipient after completion of said academic program.

13. The method of claim 9, said at least one condition of employment of said loan recipient comprising the length of time the loan recipient maintains said employment in said geographic area.

14. The method of claim 8 wherein said related academic program provides graduates adequately prepared to accept employment that addresses said work force deficit.

15. The method of claim 9 wherein said investor's investment is represented by a bond which said investor may trade with or sell to another investor.

16. The method of claim 8 said rate reduced in relation to the period of time for which said loan recipient retains employment in said geographic area that addresses said work force deficit.

17. An affordable student loan comprising a variable interest rate, said variable rate conditioned on the characteristics of the applicant for the loan, the academic program in which the applicant is enrolled, and the relationship between a work force deficit in a particular geographic area, the preparation of graduates from said academic program to meet the deficit in the work force, and the time period during which a graduate from said program retains employment that addresses said deficit.

18. The loan of claim 17 funded by a plurality of investors, represented by a plurality of bonds representing each investment made by each of said plurality of investors, and a secondary bond market in which said plurality of bonds may be transferred.

19. A method of reducing student loan interest rates through creation of a secondary bond market comprising providing competitive rates for student loans to students enrolled in an educational program that will qualify the student for employment as an employee in a targeted sector of a workforce in a specific geographic area.

20. The method of claim 19, wherein said interest rate is reduced at least once relative to said student's employment over time in said specific geographic area.
